(19) United States
(12) Patent Application Publication
(10) Pub. No.: US 2017/0169444 A1
(43) Pub. Date: Jun. 15, 2017

(54) SYSTEMS AND METHODS FOR DETERMINING CONSUMER ANALYTICS

(71) Applicant: Invensense, Inc., San Jose, CA (US)

(72) Inventor: Michael D. Housholder, San Jose, CA (US)

(21) Appl. No.: 15/373,780

(22) Filed: Dec. 9, 2016

Related U.S. Application Data
(60) Provisional application No. 62/265,710, filed on Dec. 10, 2015.

(51) Int. Cl. G06Q 30/02; H04W 4/02

(52) U.S. Cl. CPC G06Q 30/0201; G06Q 30/0261; G06Q 30/0267; G06Q 30/0255; H04W 4/027; G06Q 20/20

(57) ABSTRACT

Systems and methods are disclosed for deriving consumer analytics. A portable device associated with a user that output sensor data representing motion of the portable device, and by extension, the user. A trajectory may be derived using the sensor data and dwell periods occurring in the trajectory may be identified. By correlating dwell periods with product information including known locations of products along the trajectory, unconverted interactions may be declared in conjunction with point of sale information regarding products purchased during the trajectory.

### CROSS-REFERENCE TO RELATED APPLICATIONS

This application claims priority from and benefit of U.S. Provisional Patent Application Ser. No. 62/265,710, filed Dec. 10, 2015, which is entitled “Consumer Retargeting for Brick and Mortar Retail Using a Mobile Device and Indoor Shopper Location History,” which is assigned to the assignee hereof and is incorporated by reference in its entirety.

### FIELD OF THE PRESENT DISCLOSURE

This disclosure generally relates to techniques for determining a route traversed by a portable device and more particularly to the use of item interactions in conjunction with motion sensor data when determining the route.

### BACKGROUND

Current trends in technology have resulted in a proliferation of portable devices that are equipped with various forms of motion sensing capabilities. For example, motion sensors are now commonly included in a wide variety of devices, including mobile phones (e.g., cellular phone, a phone running on a local network, or any other telephone handset), personal digital assistants (PDAs), video game players, video game controllers, activity or fitness tracker devices (e.g., bracelet or clip), smart watches, other wearable devices, mobile internet devices (MIDs), personal navigation devices (PNDs), digital still cameras, digital video cameras, binoculars, portable music, video, or media players, remote controls, or other handheld devices, or a combination of one or more of these devices. The sensors of such devices may be used for determining position or motion, typically by employing navigation techniques based upon the integration of specific forces and angular rates as measured by the motion sensors in order to determine a route traversed by the portable device.

The existence of portable devices with such motion detection capabilities has led to an expanding variety of applications involving the selective delivery of information based on the location context or position of the device. Common examples include navigation aids that may be used to guide a user to a desired destination, social networking applications that may inform the user about others that may be in proximity, and targeted advertising schemes that may provide information relative to the user's location or tracking utilities that may provide information about a user's whereabouts as well as other location based service (LBS) applications. Particularly in a retail context, information regarding the route traversed by a portable device, and by extension, the user, represents a valuable source of information for marketing, product placement and other uses. For example, in the retail context there is a lot of interest in knowing the products that a user looks at, but does not buy, which are so-called missed conversions or unconverted interactions.

Despite the advantages of position determination capabilities, the motion sensors employed by a portable device are often constrained by space, available power, expense and other factors. As a result, such sensors typically suffer from relatively high noise and random drift rates that present challenges when used for navigation purposes and other position determinations. For example, dead reckoning techniques may be used to provide information about the motion of a portable device by determining a traversed route, but the accuracy of such solutions tends to degrade rapidly over time without other independent sources of position information for calibration. In some implementations, a portable device may receive position information from a Global Navigation Satellite System (GNSS) that, under the proper conditions, may provide precise information about the geographic location of the device. However, GNSS performance may be subject to degradation when visibility of the satellites is reduced, such as in an indoor environment. Alternative means for determining the position of a portable device include wireless local area network (WLAN) ranging, positioning based on cellular reception, and other wireless signal triangulation techniques. However, the accuracy of these methods may not be sufficient to properly supplement dead reckoning determinations of a portable device using motion sensors. Other positioning techniques, such as those relying on WiFi™, Bluetooth™, radio frequency identification (RFID) and other near field communication (NFC) systems typically require significant infrastructure investments and/or setup cost.

From the above discussion, it will be appreciated that there remains a need for using position information of a portable device determined from motion sensors to obtain a better understanding of user behavior. In a retail context, the determination of the exact position and behavior of the user can be used to analyze unconverted interactions, and perform subsequent selective retargeting. Further, it would be desirable to provide such supplementation without requiring supporting infrastructure. This disclosure satisfies these and other needs as described in the following materials.

### SUMMARY

As will be described in detail below, this disclosure includes a method for deriving consumer analytics of a first user, wherein the first user is associated with a portable device. The method may involve obtaining sensor data for the portable device representing motion of the portable device at a plurality of epochs over a first period of time, deriving a trajectory for the portable device for the first period of time based at least in part on the sensor data, identifying at least one dwell period within the trajectory, obtaining point of sale information corresponding to the first period of time, correlating each dwell period with product information and declaring at least one unconverted interaction based at least in part on a dwell period correlated with product information and the point of sale information, wherein the consumer analytics comprises the unconverted interaction.

The disclosure also includes a portable device associated with a user for deriving consumer analytics. The portable device may have an integrated sensor assembly, configured to output sensor data representing motion of the portable device for the portable device at a plurality of epochs over a first period of time and a consumer analytics module to obtain sensor data from the integrated sensor assembly, derive a trajectory for the portable device for the first period of time based at least in part on the sensor data, identify at least one dwell period within the trajectory, obtain point of sale information corresponding to the first period of time, correlate each dwell period with product information and declare at least one unconverted interaction based at least in part on a dwell period correlated with product information and the point of sale information, wherein the consumer analytics comprises the unconverted interaction.

This disclosure also includes a remote processing resource for deriving consumer analytics of a user. The remote processing resources may have a communications module for receiving information provided by a portable device associated with the user, wherein the information corresponds to a plurality of epochs over a first period of time of sensor data representing motion of the portable device and a consumer analytics module to derive a trajectory for the portable device for the first period of time based at least in part on the received information, identify at least one dwell period within the trajectory, obtain point of sale information corresponding to the first period of time, correlate each dwell period with product information and declare at least one unconverted interaction based at least in part on a dwell period correlated with product information and the point of sale information, wherein the consumer analytics comprises the unconverted interaction.

Further, the disclosure includes a system for deriving consumer analytics of a user. The system may include a portable device comprising an integrated sensor assembly, configured to output sensor data representing motion of the portable device for the portable device at a plurality of epochs over a first period of time and a communications module for transmitting information corresponding to the epochs. The system may also include remote processing resources configured to receive the information from the portable device, with a consumer analytics module to derive a trajectory for the portable device for the first period of time based at least in part on the received information, identify at least one dwell period within the trajectory, obtain point of sale information corresponding to the first period of time, correlate each dwell period with product information and declare at least one unconverted interaction based at least in part on a dwell period correlated with product information and the point of sale information, wherein the consumer analytics comprises the unconverted interaction.

### BRIEF DESCRIPTION OF THE DRAWINGS

FIG. 1 is a schematic diagram of a portable device having position determination capabilities according to an embodiment.

FIG. 2 is a schematic map showing a retail venue within dwell periods may be identified along a trajectory of the portable device according to an embodiment.

FIG. 3 is a flowchart showing a routine for deriving consumer analytics according to an embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more motion processing units (SPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU and a microprocessor, a plurality of microprocessors, one or more microprocessors in conjunction with an SPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

As noted, techniques exist for determining location or position information for a portable device associated with a user. Motion sensor data may be used with known techniques such as dead reckoning to determine a current position by extrapolating from a previous position based on deduced speed and orientation. Since such techniques may suffer from cumulative errors, the accuracy of a dead reckoning solution may be improved by supplementing the determinations with sources of position information that are independent from the motion sensor navigation system. As used herein, the term “anchor point” means a source of position information that is known without reference to motion sensor data. Accordingly, this disclosure includes identifying interactions between the user and a plurality of items. Each of these items may be established as an anchor point by associating a known location with the item. Correspondingly, the motion sensor data for the portable device for a period of time encompassing the identified interactions may be used to generate a route traversed by the portable device that provides the best fit to the established anchor points. The interaction may involve any relationship that represents proximity between the user and the item. In the following materials, embodiments in a retail context are discussed and suitable interactions include selecting items for purchase and point of sale transactions. However, as will be appreciated, many other interactions constitute sufficient proximity so that a known location of the item may be used as an anchor point when generating the route traversed by the portable device.

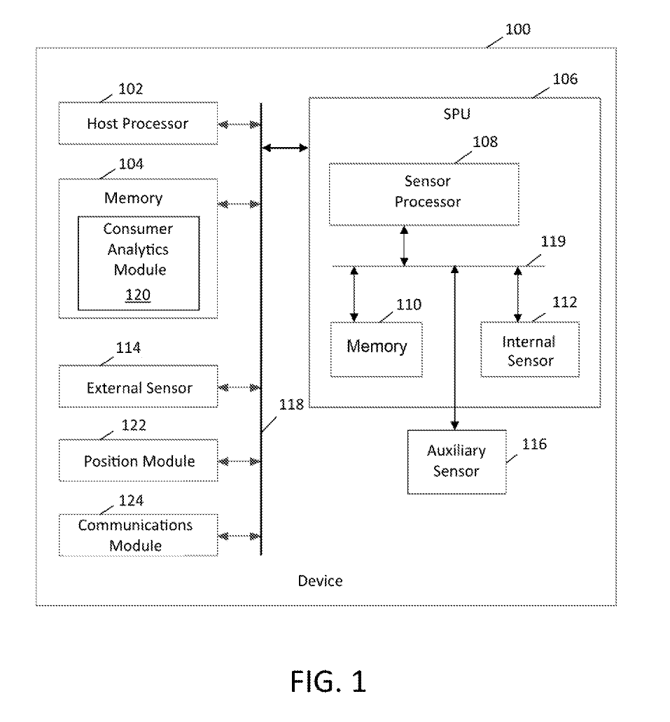

As noted above, a portable device embodying aspects of this disclosure may include a sensor assembly including internal sensors, such as e.g. inertial sensors, providing measurements that may be used to develop or enhance a navigation solution for the portable device and the user by extension. To help illustrate these features, a representative portable device 100 is depicted in FIG. 1 with high level schematic blocks. As will be appreciated, device 100 may be implemented as a device or apparatus, such as a handheld, portable electronic device. For example, such a computing device may be a desktop computer, laptop computer, tablet, portable computer, portable phone (e.g., cellular smartphone, a phone running on a local network, or any other telephone handset), wired telephone (e.g., a phone attached by a wire), personal digital assistant (PDA), video game player, video game controller, (head-mounted) virtual or augmented reality device, navigation device, activity or fitness tracker device (e.g., bracelet or clip), smart watch, other wearable device, portable internet device (MID), personal navigation device (PND), digital still camera, digital video camera, binoculars, telephoto lens, portable music, video, or media player, remote control, or other handheld device, or a combination of one or more of these devices.

As shown, device 100 includes a host processor 102, which may be one or more microprocessors, central processing units (CPUs), or other processors to run software programs, which may be stored in memory 104, associated with the functions of device 100. Multiple layers of software can be provided in memory 104, which may be any combination of computer readable medium such as electronic memory or other storage medium such as hard disk, optical disk, etc., for use with the host processor 102. For example, an operating system layer can be provided for device 100 to control and manage system resources in real time, enable functions of application software and other layers, and interface application programs with other software and functions of device 100. Similarly, different software application programs such as menu navigation software, games, camera function control, navigation software, communications software, such as telephony or wireless local area network (WLAN) software, or any of a wide variety of other software and functional interfaces can be provided. In some embodiments, multiple different applications can be provided on a single device 100, and in some of those embodiments, multiple applications can run simultaneously. As an example, suitable application may include those provided by a retailer or third-party designed to facilitate shopping or other retail consumption by a user of device 100, such as by delivering advertisements or offers regarding one or more products.

Device 100 includes at least one sensor assembly, as shown here in the form of integrated sensor processing unit (SPU™) 106 featuring sensor processor 108, memory 110 and internal sensor 112. Memory 110 may store algorithms, routines or other instructions for processing data output by internal sensor 112 and/or other sensors as described below using logic or controllers of sensor processor 108, as well as storing raw data and/or motion data output by internal sensor 112 or other sensors. Internal sensor 112 may be one or more sensors, such as e.g. inertial sensors, for measuring motion of device 100 in space. Depending on the configuration, SPU 106 measures one or more axes of rotation and/or one or more axes of acceleration of the device. In one embodiment, internal sensor 112 may include rotational motion sensors or linear motion sensors. For example, the rotational motion sensors may be gyroscopes to measure angular velocity along one or more orthogonal axes and the linear motion sensors may be accelerometers to measure linear acceleration along one or more orthogonal axes. In one aspect, three gyroscopes and three accelerometers may be employed, such that a sensor fusion operation performed by sensor processor 108, or other processing resources of device 100, combines data from internal sensor 112 to provide a six axis determination of motion. The internal sensor may also include a pressure sensor, and the pressure data may be fused with the motion data for an accurate determination of the height (changes) of device 100. Still further, the internal sensor 112 may be a magnetometer or any of the other sensors noted herein. As desired, internal sensor 112 may be implemented using MEMS to be integrated with SPU 106 in a single package. Exemplary details regarding suitable configurations of host processor 102 and SPU 106 may be found in commonly owned U.S. Pat. No. 8,250,921, issued Aug. 28, 2012, and U.S. Pat. No. 8,952,832, issued Feb. 10, 2015, which are hereby incorporated by reference in their entirety. Suitable implementations for SPU 106 in device 100 are available from InvenSense, Inc. of San Jose, Calif.

Alternatively, or in addition, device 100 may implement a sensor assembly in the form of external sensor 114. External sensor 114 may represent one or more sensors as described above, such as an accelerometer and/or a gyroscope, that measure motion, as well as sensor(s) for detecting other conditions. As used herein, “external” means a sensor that is not integrated with SPU 106. For example and without limitation, external sensor 114 may also include an optical sensor, such as a digital image sensor, a thermometer, a hygrometer, a pressure sensor, a barometer, an acoustic sensor, an ambient light sensor or any other sensor that measures characteristics of the environment surrounding device 100, or combination thereof. In the context of this disclosure, external sensor 114 may also include a wireless communication receiver and may correspondingly detect radiofrequency signals. For example, external sensor 114 may be used to obtain a data for use in determining a location of device 100 for use in a deriving consumer analytics in accordance with this disclosure. Also alternatively or in addition, SPU 106 may receive data from an auxiliary sensor 116, which may be one or more of any of the sensors disclosed herein, such that auxiliary sensor 116 may also be used for determining a location of device 100 when deriving consumer analytics in accordance with this disclosure.

As one example, a barometer and/or a magnetometer may also be implemented as internal sensor 112, or any other architecture, for use in refining the position determinations being made. In one embodiment, a magnetometer measuring along three orthogonal axes and output data to be fused with the gyroscope and accelerometer internal sensor data to provide a nine axis determination of motion. In another embodiment, a barometer may provide an altitude determination that may be fused with the other sensor data to provide a ten axis determination of motion.

In the embodiment shown, host processor 102, memory 104, SPU 106 and other components of device 100 may be coupled through bus 118, while sensor processor 108, memory 110, internal sensor 112 and/or auxiliary sensor 116 may be coupled though bus 119, either of which may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, a serial peripheral interface (SPI) or other equivalent. Depending on the architecture, different bus configurations may be employed as desired. For example, additional buses may be used to couple the various components of device 100, such as by using a dedicated bus between host processor 102 and memory 104.

In one aspect, various aspects of this disclosure may be used to derive consumer analytics for a user of portable device 100 from motion sensor data. For example, it will be appreciated that an important indicator of consumer interest is the amount of time spent by the user in association with a product, a class of products, a brand or the like. As the user navigates along a trajectory in the retail venue, interest may be inferred when the user stops moving along the trajectory and dwells at one point or region. Further, even though a user may spend a period of time considering a given product, that user may not purchase the product at that time for any variety of reasons. As used herein, this scenario is termed an “unconverted interaction,” reflecting that the user's consideration of the product did not result in a sale. Those of skill in the art appreciate that an unconverted interaction represents a significant opportunity to increase sales. In recognition of the evident consumer interest, it may be desirable for a retailer to tailor advertising or sales offers to the user when an unconverted interaction is identified.

Within an online context, a number of tools exist to facilitate such advertisement. Notably, it is relatively trivial to identify a user's interest in a given product by simply parsing the web searches or links followed by the user and associating information regarding that interest, such as in the form of “cookies” or “pixels” stored by the user's internet browser. Consequently, that information may be supplied to a relevant retailer who is then able to communicate targeted advertisements or offers to the user, a practice which is typically termed “retargeting advertisement” or “retargeting.” Enabling an advertisers to retarget specific consumers who have shown interest in a given product due to their online behavior is widely considered to be more valuable when compared to more generic approaches that convey information indiscriminately or only on the basis of demographics. As a result, greater proportions of advertising budgets are being allocated to retargeting and current estimates of the scale exceed $5 billion dollars, illustrating the value of providing relevant techniques.

While methods for retargeting have been developed and implemented for online consumers as noted above, equivalent techniques have not been available for a user within a retail venue or in other offline contexts. Accordingly, the technique of this disclosure may be applied to derive consumer analytics for a user from sensor data for a portable device associated with the user. For example, the consumer analytics may include one or more unconverted interactions. As will be discussed in more detail below, determination of unconverted interactions may be based, at least in part, on one or more dwell periods occurring within a trajectory of the portable device, which may be generated from motion sensor data. Moreover, each dwell period may be correlated with product information for the location where the dwell occurred. By excluding dwell periods corresponding to products that were actually bought, one or more unconverted interactions may be declared and used, for example, to convey an offer or other advertising to the user.

Correspondingly, consumer analytics module 120 may be implemented as a set of suitable instructions stored in memory 104 that may be read and executed by host processor 102. Notably, consumer analytics module 120 may utilize motion sensor data, such as from internal sensor 112 and/or external sensor 114 using a dead reckoning or similar technique to determine a current position of device 100 in relation to a previously determined position. In aggregate, the sequence of determined positions of device 100 may be considered a trajectory being traveled by the user through a venue, such as a retail store or the like. In one aspect, an interval of time in which relatively little motion is recorded, or where motion is confined to a defined region of the trajectory, may correspond to a dwell period, during which it may be expected the user is interacting with a product for sale or other suitable item.

In some embodiments, a positive association may be made between products purchased and known locations of the products to establish one or more anchor points to aid position determination of device 100. As detailed in co-pending, commonly-assigned U.S. patent application Ser. No. 14/710,511, filed May 12, 2015 and entitled “Systems And Methods For Determining A Route Traversed By A Portable Device,” which is hereby incorporated in its entirety by reference, the user may select a product, potentially during a dwell period, and subsequently purchase it. Confirmation of the purchase may be accomplished through use of point of sale information or the like. Further, each product may have a designated location within the venue, with the necessary information maintained in a database by the retailer or a third-party. For example, Aisle411™ of St. Louis, Mo. provides store maps and product shelf databases, although any service offering similar information may be employed. By associating the known locations of purchased items, one or more anchor points may be established to constrain or otherwise aid the determination of a trajectory for device 100 from the motion sensor data. Notably, consumer analytics module 120 may be configured to provide a best fit between motion of device 100 indicated by the motion sensor data and the established anchor point or points.

The present disclosure involves a complementary use of the product location information. In addition to the optional use of purchased products to establish anchor points to determine the trajectory of the user, consumer analytics module 120 may correlate one or more identified dwell periods with product information associated with locations where the dwell periods occurred. Rather than using the known interaction of the user with a product when purchasing it to inform the determination of position for device 100, the position of device 100 during a dwell period may be used to predict user interest in a product or products found at the location of the dwell period. Furthermore, the sensors of device 100 may be used to analyze the motion, activities, and behavior of the user during the dwell period.

Other embodiments may feature any desired division of processing between host processor 102, SPU 106 and other resources provided by device 100, or may be implemented using any desired combination of software, hardware and firmware. For example, consumer analytics module 120 may be implemented in SPU 106, such as being stored in memory 110 and executed by sensor processor 108. Alternatively or in addition, any of the operations used to derive consumer analytics may be performed remotely, such as by a server, or may be divided in any suitable manner between remote and local processing resources.

Multiple layers of software may be employed as desired and stored in any combination of memory 104, memory 110, or other suitable location. For example, a motion algorithm layer can provide motion algorithms that provide lower-level processing for raw sensor data provided from the motion sensors and other sensors. A sensor device driver layer may provide a software interface to the hardware sensors of device 100. Further, a suitable application program interface (API) may be provided to facilitate communication between host processor 102 and SPU 106, for example, to transmit desired sensor processing tasks. As such, aspects implemented in software may include but are not limited to, application software, firmware, resident software, microcode, etc, and may take the form of a computer program product accessible from a computer-usable or computer-readable medium providing program code for use by or in connection with a computer or any instruction execution system, such as host processor 102, sensor processor 108, a dedicated processor or any other processing resources of device 100.

Device 100 may also include position module 122 that employs a reference-based strategy to determine absolute location information. Position module 122 may provide any desired degree of location awareness capabilities. Representative technologies that may be embodied by position module 122 include GNSS systems, such as the global positioning system (GPS), the global navigation satellite system (GLONASS), Galileo and Beidou, as well as WiFi™ positioning, cellular tower positioning, Bluetooth™ positioning beacons, or other similar methods. As such, position module 122 may be configured to use information from a wireless communication protocol to provide a position determination using signal trilateration. Any suitable protocol, including cellular-based and wireless local area network (WLAN) technologies such as Universal Terrestrial Radio Access (UTRA), Code Division Multiple Access (CDMA) networks, Global System for Mobile Communications (GSM), the Institute of Electrical and Electronics Engineers (IEEE) 802.16 (WiMAX), Long Term Evolution (LTE), IEEE 802.11 (WiFi™) and others may be employed. In embodiments employing position module 122, the absolute location information may be used in conjunction with the inertial navigation techniques of consumer analytics module 120.

Further, device 100 may include one or more communication modules 124 for establishing a communications link, which may employ any desired wired or wireless protocol, including the protocols noted above. As desired, communications module 124 may be configured to transmit sensor data, including motion sensor data that may be used to remotely generate a trajectory traversed by device 100. Communications module 124 may also be used to receive sensor data from other devices associated with the user, such as e.g. wearable devices like a smartwatch. Device 100 may then analyze the behavior of the user during the dwell period based on all the available sensor data from the devices itself and the associated devices. Communications module 124 may also be used to receive data used for performing other operations associated with this disclosure, such as receiving product information corresponding to a dwell period location.

Although aspects of this disclosure have been described in the context of a single device, device 100, it should be appreciated that any number of devices may be employed in concert. For example, a first device may be implemented as a smartphone and a second device may be implemented as a wearable, such as a smart watch. Sensor data from either or both devices may be used when generating a trajectory representing the path of the user through a venue. Further, it will be appreciated that the use of multiple devices may facilitate other aspects of this disclosure. For example, the discussion below notes that it may be desirable to characterize the activity of the user and having a device that may be expected to be secured to a given portion of the user's anatomy may increase the accuracy of activity recognition. When multiple devices are employed to gather sensor data related to the user's trajectory through a venue, it will be appreciated that the devices may communicate such sensor data as necessary, such as through communications module 124. Moreover, each device may not require every component discussed with regard to device 100. Notably, only one implementation of consumer analytics module 120 may be provided in some embodiments, while in others, the functionality of consumer analytics module 120 may be performed by remote processing resources as discussed above.

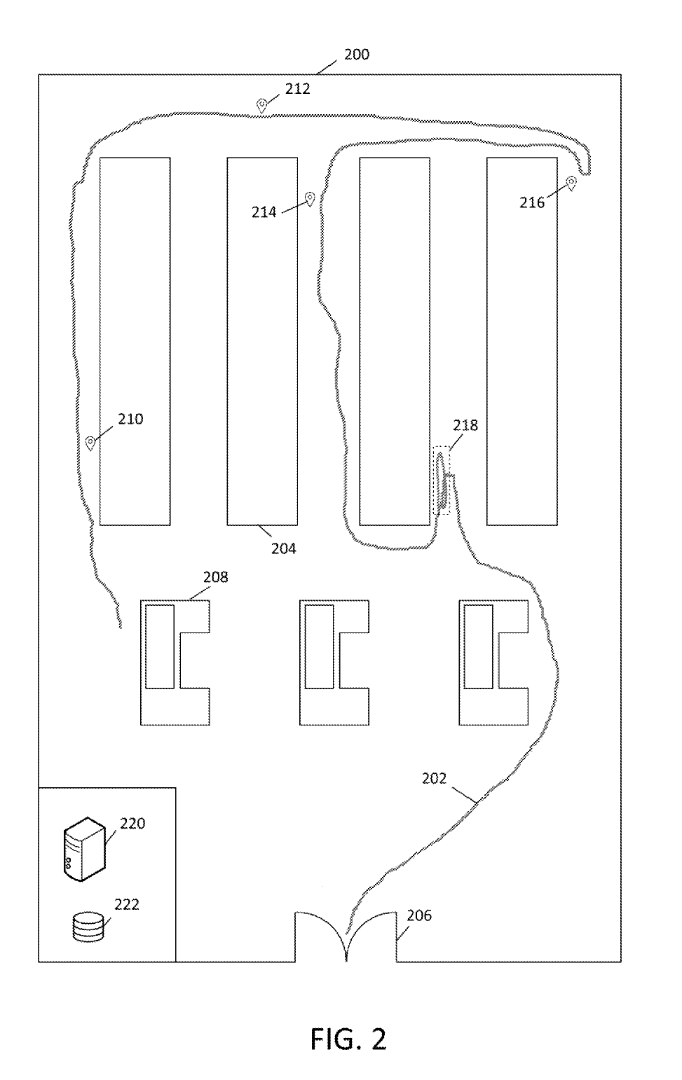

One exemplary embodiment of the techniques of this disclosure is schematically depicted in FIG. 2 in the context of a retail venue represented by store 200. As will be described, consumer interest may be imputed to the user of device 100 depending on identified dwell periods. Based on sensor data, as well as any other suitable source of information if available, consumer analytics module 120 may generate a trajectory 202 representing the path navigated by the user through store 200. The interior of store 200 may have traversable areas, such as aisles, defined by shelves 204, other product displays, structural features, or the like. In some embodiments, it may be possible to establish a start or end of trajectory 202 using information known about store 200. In this example, a start of trajectory 202 may be assumed at the entrance of store 200 based on a known location of doors 206. Similarly, an end of trajectory 202 may be assumed when the user purchases products at register 208. As noted below, a list of the products purchased at register 208 may also be used as point of sale information. Correspondingly, such features may be used as anchor points when generating trajectory 202. Other types of anchor points may also be used when generating trajectory 202. As noted above, point of sale information may be used to identify one or more products purchased as the user traversed trajectory 202. By determining a known location for a purchased product, that location may be used as an anchor point, exemplified here as anchor point 210. An anchor point, such as anchor point 212, may also be established using a source of absolute navigation information obtained with position module 122.

Likewise, map information may exist for store 200 or any other location for which these techniques are applied. Correspondingly, the generation of trajectory 202 may be constrained by features associated with the map information, such as by assuming the user must be moving along the aisles and other passageways and not moving through shelves 204 or other fixed objects. In yet another aspect, the generated trajectory may be used to build or update map information by employing the same reasoning. Notably, the concepts may be extended to information aggregated from multiple visits and/or multiple users. A preponderance of the generated routes may be used to validate product location information, derive map information, gather supplemental sensor data, or for any other purpose.

Over the course of trajectory 202, consumer analytics module 120 may identify one or more dwell periods during which device 100 is relatively motionless or during which motion of device 100 is confined to a defined region. To help illustrate, dwell periods 214 and 216 are indicated as a point, representing that device 100 is relatively motionless. Motionlessness may be determined in any suitable manner, such as by determining that device 100 has not been displaced beyond a threshold during the dwell period, by determining that one or more of the sensors, including any of internal sensor 112, external sensor 114 and/or auxiliary sensor 116, are not experiencing any specific forces indicative movement that exceed a threshold. As an example only, internal sensor 112 may be an accelerometer, and therefore may not measure linear acceleration along any sensitive axis exceeding the threshold that is not attributable to gravity during a dwell period. Such motionlessness may occur due to the user reading a product label or otherwise considering a purchase. Correspondingly, a dwell period in this context may be considered to be indicative of consumer interest in a product located at the position along trajectory 202 where dwell period 214 or 216 occurs.

In another aspect, a dwell period may correspond to a range of movement that is confined to a threshold region. For example, dwell point 218 is indicated as a dashed box, encompassing back and forth motion of the user in front of a shelf. As such, the dwell period will correspond to a dwell region or a dwell location range. As will be appreciated, this type of motion may be ascribed to the user considering more than one product. If desired, identification of dwell points comprising a region may be confirmed in relation to the product information associated with the involved locations. Notably, if the range of locations correspond to competing products, it may be likely that the user is deciding among the options. Within a dwell period, and within the associated dwell region, consumer analytics module 120 may further determine whether the user spends more time at a certain subset of locations within the region than at another subset of locations. For example, a dwell region may be divided into sub-regions, and the time spend within each sub-region may be determined. This analysis may provide more insight in the amount of interest of the consumer in the various products or product ranges associated with the sub-regions. For example, it may be determined that during the dwell period, the consumer looked at product A for 10 seconds, and at product B for 20 seconds. In other words, the consumer analytics module 120 will analyze the location/time distribution within the dwell region to obtain more detailed information about the interest of the consumer, and may then use this information for the retargeting. Conversely, if different products are associated with the locations or region, it may be less likely that the portion of trajectory should be considered a dwell point indicative of consumer interest. In some aspects, a dwell period may correspond to more than one dwell position, and the different dwell positions may be split, each corresponding to a separate interest of the user (and used for retargeting). Further, although motion of device 100 in dwell period 218 is illustrated as movement in the X-Y plane, it should be appreciated that the range of motion may also involve movement along the Z-axis. For example, the competing products being considered by the user may be arranged vertically instead of, or in addition to, horizontally.

Although aspects of this disclosure have been described as being performed locally by device 100, such as through consumer analytics module 120, in other embodiments, any or all of these operations may be performed remotely, such as by server 220 or any other remote processing resources. For example, the motion sensor data from device 100 may be transmitted by communications module 124 and used by server 220 to generate trajectory 202. Likewise, server 220 may also provide the functionality necessary to identify dwell periods, correlate product information with those dwell periods, obtain point of sale information and/or declare unconverted transactions as described herein. Likewise, server 220 or other remote processing resources may receive information from a number of portable devices, one or more of which are associated with distinct users and derive consumer analytics for each user. Further, the consumer analytics derived for each user may be combined as desired.

In a further aspect, the product information that may be correlated with a dwell period may depend on a number of factors, including characteristics of the dwell period and/or the precision of the product information with respect to location within store 200. As noted above, information about the known locations of products within store 200 may be maintained in database 222 and may be accessible by consumer analytics module 120 and/or server 220, depending on the embodiment. As a first example, a dwell period may reflect an interval in which device 100 is relatively motionless as discussed above. Accordingly, a specific position for device 100 may be determined for the dwell period. In some embodiments, the position may be two dimensional, such as in the X-Y plane. In other embodiments, the position may be three dimensional, such as by including information about position along the Z-axis. For example, the sensor data from device 100 (or from multiple devices in such embodiments) may be processed to determine a user posture or user posture information, wherein the user posture information contains any information related to the posture and activity of the user aimed at an interaction with products during the dwell period. Some of these calculation may require some input about the user, such as e.g. the height or reach. Notably, the user may be crouching to look at a product located on a lower shelf or stretching overhead to reach a product at an elevated location. This may be facilitated when device 100 is associated with the user's hand or arm, such as in a smartwatch embodiment. As discussed above, a dwell period may encompass a range of movement, which may include a change in posture. For example, a user may be standing when considering a product displayed at eye level and then may crouch when considering a product displayed at a lower elevation. Alternatively, or in addition, it may be desirable to employ information from a sensor tailored to sense changes in relative height, such as a pressure sensor. Thus, the product information that may be correlated with a dwell period may include an identification of any product or products known to exist at the determined two dimensional or three dimensional position. Analysis of the user's posture and activities may only be required during a dwell period. Therefore, device 100 may only activate these processes once a dwell period is detected in order to avoid any unnecessary use of power and computing resources. This includes only communication with other device when needed during the dwell periods. The characteristics of the dwell period thus include any information or characteristics that can be deduced from the motion, posture, and activities of the user during the dwell period.

In order to more accurately correlate a dwell period with product information, consumer analytics module 120 may utilize posture information regarding the user as noted above. For example, based on the sensor reading from a smartphone and/or a smartwatch, consumer analytics module 120 may be able to determine which product the user is reaching for. In one aspect, the consumer analytics module 120 may contain models that convert sensor readings to posture information, such that the models may include the dynamics of a human body. In another aspect, consumer analytics module 120 may learn or adapt these models based on the user's behavior. For example, for converted interactions, the product that the user has reached for may be known since the user bought this product, for example by combining the point of sale information with the product location information. The posture information and the activity information for the dwell period corresponding to the converted interaction can then be analyzed to extract correct sensor readings or otherwise model the behavior that is now known from the converted interaction. These sensor readings during the action of taking this product may thus be linked to the product location. These sensor readings and the associated product location may therefore be used in a learning process, for example using Hidden Markov models or other gesture learning models, to determine the models and their required parameters. For example, using this approach, it may be learned when the user is bending, reaching or engaged in another posture to get to products, and to what product location. The advantage of learning from the converted interaction is that the models and its parameters may be optimized for the user. The models learned from the converted interaction may then be applied to the unconverted interactions to refine the location being correlated with product information to estimate consumer interest in one or more products. By analyzing the sensor data discussed above for converted and unconverted interactions in the same session or visit to the retail venue, the likelihood of the user carrying the device in a similar manner is higher, which improves the accuracy of the correlation between sensor readings from converted and unconverted interactions. If this is not the case, any influence of how the user carries the mobile device may be corrected for. These learned models may also be applied to other users, although not being optimized for that user. This would most likely reduce the accuracy of the determined interaction, which should then be taken into consideration for the retargeting.

If the product location database has relatively precise information, it may be possible to identify a single product that correlates to the location, while less precise information may allow identification of a particular brand or a class of products. Further, even less precision may still allow identification of a general category of products. Generally, the product information may have a detail level that is related to the precision of available product locations. For the sake of illustration, the range of detail level may be from a specific model of toothbrush from a single manufacturer, to a range of toothbrushes from that manufacturer, to different competing toothbrushes from multiple manufacturers, to dental products in general or even to a broader category such as health and beauty aids. While the different levels of precision in product information may represent different utility when deriving consumer analytics, it will be appreciated that any information that may be determined to constitute consumer interest has value. The detail level may cover the widest relevant grouping to the most detailed possible item, or the like.

Similarly, it may be possible to assign an uncertainty to the position determinations used when generating trajectory 202, meaning that the determined position has an uncertainty and that the position refers to a range of possible positions. As desired, the product information that is correlated with a dwell period may depend, at least in part, on that uncertainty. For example, when a relatively greater degree of uncertainty exists, consumer analytics module 120 may use an aisle or area of the store when correlating product information, such as by including all products known to be located along that aisle or in that area. However, when a determined position has relatively less uncertainty, greater precision in location may be used to correlate the product information, so that as the uncertainty decreases, the location associated with the dwell period may be refined. Thus, the detail level of the product information correlated with a dwell period may also vary depending upon which products are within the range of uncertainty. As an illustration only, the location used to correlate product information may range from an aisle or area as noted above, to a grouping of shelves, to a specific shelf to a specific location along a shelf. Similarly, when relative height information is available, the accuracy with which the postures and/or activities of the consumer may be determined influences the vertical precision of the determined. The consumer analytics module 120 may combine the accuracy of the determined location with the details of the product location in order to determine the product that the consumer is interested in. It is apparent that the consumer analytics module 120 can only identify products if both the position has been determine accurately, and the product location information is detailed enough. As such, the device may adapt to accuracy of the position calculation based on the available detail of the product location information. There is no use in determining an accurate position if no detailed product location information is available. This use means, for example, that if no vertical product location information is available, there is not use in trying to analysis the posture or activities of the user during the dwell period. With this approach, the device does not use any unnecessary power and computing resource in determining an accurate location.

It will be appreciated that one desirable form of consumer analytics is the identification of unconverted interactions, which may be used for retargeting or other applications. The above discussion illustrates the correlation of a dwell period with product information under the assumption that the delay in a user's trajectory indicates consumer interest in a product or products that may be found at the location where the user dwells. This disclosure further contemplates that such consumer interest may be analyzed to identify an unconverted interaction. As noted, an unconverted interaction comprises a scenario in which the user's contemplation of a product did not result in a sale. Conversely, the user's trajectory may also involve one or more converted interactions, in which the user purchased the product(s).

Accordingly, it may be desirable to obtain point of sale information to aid in distinguishing dwell periods that correspond to unconverted interactions. In one embodiment, this may involve obtaining a list of items purchased as determined at register 208 when the user checks out, for example. However, these techniques may also be applied to other retail models. For example, some stores may employ “smart” shopping carts that identify and/or sell items as they are added to the cart using RFID or equivalent technology. In another example, sales may be finalized by scanning products as the user exits the store. Yet another example is the use of device 100, or another dedicated device, to create a virtual shopping cart by scanning display items to create a purchase order that then may be fulfilled from a warehouse. As such, these and other methods of transaction constitute point of sale information that may be used to identify items with which the user has purchased.

Point of sale information may be used in any suitable manner when deriving consumer analytics according to the techniques of this disclosure. It may be appreciated that when a user purchases a product, a dwell period associated with selecting that product may not constitute an unconverted interaction. Therefore, in one embodiment, declaring an unconverted interaction may involve excluding any dwell period that corresponds to a product that was purchased, as determined from the point of sale information. However, other embodiments may accommodate scenarios in which a user considers a plurality of competing products during a dwell period and subsequently purchases one of them. Particularly, the considered, but not purchased, products may be considered to represent unconverted interaction and it may be desirable to retarget the user. Based on characteristics of the dwell period, consumer analytics module 120 may be configured to declare an unconverted interaction even if a product is purchased. For example, the length of time involved in the dwell period may indicate the user was evaluating the merits of competing products, such that one or more unconverted interactions may be declared with respect to competitors of the product actually purchased. As another example, the dwell period may encompass a range of motion as discussed above with respect to dwell period 218. Correspondingly, this may indicate the user considered other products located within the range of motion before purchasing the product reported in the point of sale information. Again, consumer analytics module 120 may be configured to declare an unconverted interaction with respect to these products.

In another aspect, consumer analytics module 120 may elect to declare an unconverted interaction based at least in part on a determined use of device 100 during the dwell period. As discussed above, a dwell period may indicate the user is considering purchasing a product in the current vicinity. However, other user behavior may cause the dwell period, such as making a phone call, texting, taking a picture, playing a game or any number of other possible activities that may involve device 100. Determination of use may involve recognizing a user activity, such as by analyzing patterns of sensor data or may be based on application(s) being executed by host processor 102, sensor processor 108 or other computing resources of device 100. The determination of use may be taken as a positive indication of an unconverted interaction if a relationship may be established to product information associated with the dwell period, such when the user is browsing a related topic on the internet, or may be taken as a negative indication when no relationship is established. In the later situation, the location associated with the dwell period may be neglected and may not be used for further consumer analysis.

Given the noted value of retargeting, aspects of this disclosure involve conveying an offer to the user based upon the declaration of an unconverted interaction. As a relatively straightforward example, an identified dwell period may be associated with a known location of a corresponding product, such that an advertisement for the product may be directed to the user. However, many other variations are within the scope of this disclosure. For example, the advertisement may be for a product, not purchased during the trajectory, that is related to a purchased product. Depending on the detail level of the product information, and/or the uncertainty of position for device 100, the advertisement may be more general, such as for a particular brand or class of product. Still further, it may be desirable to focus the retargeting on a subset of the unconverted interactions. For example, this may be based on characteristics of the dwell period. As an illustration, a relatively longer dwell period may be taken to indicate a greater degree of interest as compared to relatively shorter dwell periods. The offer may be conveyed, for example by server 220, the device 100 or any other devices of the user. The timing of the offer may be adapted to the situation or to the preferences of the user. In one aspect where the point of sale information is used, the offer may be constructed and conveyed as soon as the point of sale information is available. In a further aspect, the offer may be conveyed at a later time, for example when it is detected that the user is coming back to the retail venue, or a competitor's venue.

In a further aspect, the offer conveyed based on an unconverted interaction may be adjusted based on any suitable factor, including characteristics of the dwell period, the product information and/or the point of sale information. For example, the point of sale information may indicate the user purchased a competing product. Correspondingly, the retargeting advertisement may include a more generous offer under the assumption that the user will require greater incentive to subsequently purchase the retargeted product. Alternatively, a different unconverted interaction may be selected as the basis for retargeting under the assumption that the user has already chosen the competing product. Other sources of information may also be used to adjust the offer. For example, a user's history may indicate a preference for buying a given brand, so that the retargeting advertisement may include a more generous offer to overcome that preference. If detailed product information is available, the consumer analytics module 120 may deduce if the consumer is looking for the presence or absence of certain ingredient. For example, the user may look for a product with the lowest amount of sugar or fat. Based on comparison of the missed conversions and the purchased products, a certain profile of the interests of the user may be determined, which may influence the retargeting decisions. The analysis may be based on the current visit to the retail venue, or may also include information from past visits.

Although embodiments above have been described in the context of deriving consumer analytics for a single user, it will be appreciated that these techniques may be extended to any number of users. For example, consumer analytics derived for one user may be applied to another based upon some relationship. The users may be in the same family or organization, or may share an identified common interest. In another aspect, a relationship may be determined between users based on other factors, such as purchasing behavior or any other suitable metric. Aggregating consumer analytics for multiple users may enable a wide range of crowd sourcing applications, using any known technique. For example, when two or more members of the same family go shopping together, their dwell period information may be combined. The retargeting based on the combined dwell period information based be directed to one or more of the members, where the selection is based on the members profile (age, gender, interests). The system may have information about the family composition, and the devices associated with the different members so that the information from the different consumer analytics modules 120 in the different devices may be combined, either in one or more of the device or on a remote server. In embodiments where the system does not know beforehand which devices belong to members of a group, these devices may be determined based on the location/time information. For example, members of the group usually enter and exit the retail venue within a short time span, and also meet regularly within the retail venue. Based on the overlap of the position as a function of time, devices belonging to the same family or group may be determined. Example methods of how to link different devices to a single entity based on location information are discussed in co-pending, commonly assigned U.S. Provisional Patent Application Ser. No. 62/280,550, filed Jan. 16, 2016 and entitled “Integrating User Data Across Multiple Devices for Effective Advertisement Retargeting,” which is incorporated by reference in its entirety by reference. The system may request a confirmation from the various members before merging the information.

From the above, it will be appreciated that trajectory 202 represents a valuable source of information regarding the behavior of the user. For example, in a retail context, the traversed route provides analytics regarding a wide range of consumer behavior. The activity of the user is of considerable interest to retailers, manufacturers, advertisers and other commercial entities. The analytics may be used for designing store layout and product placement to enhance sales, as well as offering insight into successful packaging designs, advertising strategies and similar methods of influencing purchasing decisions. In one embodiment, such analytics may include the sequence in which items are selected for purchase and the demographics associated with purchase sequence and/or the traversed route. As noted, the analytics may also be aggregated to provide characterization of one or multiple demographics of a plurality of users, of different stores or locations, of different times of day, and the like. Analytics may also be aggregated for one user at one or multiple locations in order to assess changing patterns of behavior. As will be appreciated, a variety of other information may be derived by correlating dwell points along a user's trajectory with product information for products having known location along the trajectory, all of which are within the scope of this disclosure.

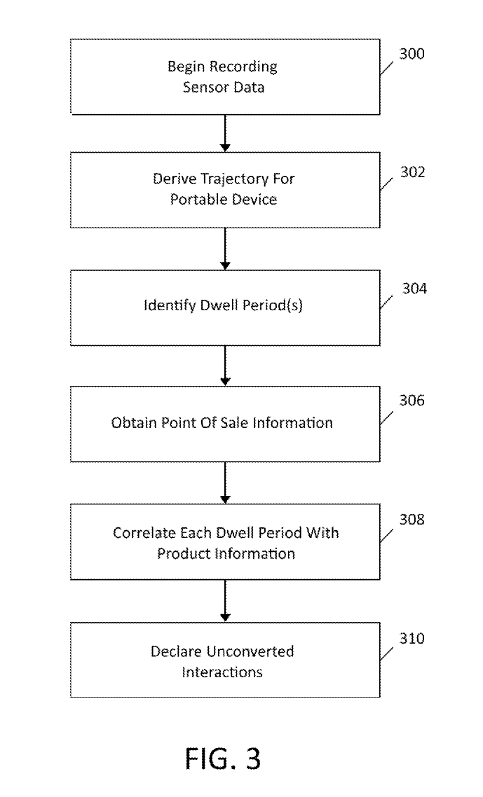

Further aspects of this disclosure are illustrated with respect to the flowchart shown in FIG. 3, which represents a routine deriving consumer analytics. Beginning with 300, device 100 may begin recording sensor data, including motion sensor data, such as from internal sensor 112, as well as environmental or other sensor data as desired, such as from external sensor 114 and/or auxiliary sensor 116 or any other type of sensor of device 100. Based on the sensor data, and any other suitable information when available, consumer analytics module 120, or the equivalent, may derive a trajectory representing the user's route through a venue in 302. In 304, one or more dwell periods may be identified along the trajectory. In 306, point of sale information may be obtained for a period of time encompassing the trajectory. As described above, point of sale information may include a list of products purchased over the course of the trajectory. Consumer analytics module 120 may then correlate each identified dwell period with product information in 308. The product information may include the known location of products within the venue. In 310, at least one unconverted interaction may be declared based at least in part on a dwell period correlated with product information and the point of sale information. The consumer analytics may include any declared unconverted interactions.

In one aspect, an offer may be conveyed to the first user based at least in part on the consumer analytics. The offer may be adjusted based at least in part on a dwell period characteristic, point of sale information and/or a purchase history of the user.

In one aspect, declaring at least one unconverted interaction may involve excluding a dwell period having a converted interaction based at least in part on the point of sale information.

In one aspect, declaring at least one unconverted interaction may involve distinguishing the unconverted interaction in a dwell period having a converted interaction based at least in part on a characteristic of the dwell period. An offer may be conveyed to the first user based at least in part on the unconverted interaction and the converted interaction.

In one aspect, determination of an interaction of the user with a product in an unconverted interaction may be based on an interaction of the user with a product in a converted interaction.

In one aspect, correlating each dwell period with product information may be based at least in part on comparing a determined location of the first user during the dwell period with known locations of products.

In one aspect, the product information correlated with a dwell period may have a detail level. An uncertainty for a determined location of the first user during the dwell period may be determined, such that the detail level of the product information may be based at least in part on the uncertainty. An offer may be conveyed to the first user based at least in part on the detail level of the product information. The dwell period may encompass a range of movement, such that the detail level of the product information correlated with the dwell period may be based at least in part on the range of movement.

In one aspect, posture information for the first user may be determined during a dwell period based at least in part on the sensor data, such that the product information correlated with the dwell period may be based at least in part on the determined posture information. The posture information may be matched to a pattern learned from a previous converted interaction.

In one aspect, a use of the device may be determined during a dwell period, such that declaring an unconverted interaction for the dwell period may depend at least in part on the determined use.

In one aspect, consumer analytics may be derived for a second user, such that the method may involve combining the second user consumer analytics with the first user consumer analytics. The second user may be selected from a group of users based at least in part on a relationship with the first user. The second user may be selected from a group of users based at least in part on a comparison of the derived trajectory for the first user and a derived trajectory for the second user. An offer may be conveyed based at least in part on the combined consumer analytics. The method may involve selecting among the first and second users when conveying the offer.

In one aspect, an offer may be conveyed to a second user based at least in part on the unconverted interaction, wherein the second user shares a characteristic with the first user.

In one aspect, the method may include obtaining sensor data from at least one other device associated with the user, such that at least one of deriving the trajectory and identifying at least one dwell period may be based at least in part on the sensor data obtained from the at least one other device.

As noted above, the disclosure is also directed to a portable device associated with a user for deriving consumer analytics. In one aspect, the consumer analytics module of the portable device may obtain sensor data from another device associated with the user and may declare the at least one unconverted interaction using the sensor data from the other device.

In one aspect, the portable device may initiate communication of the sensor data from the other device when a dwell period is detected.

In one aspect, the consumer analytics module may communicate the consumer analytics to remote processing resources.

In one aspect, the consumer analytics module may receive an offer based at least in part on the consumer analytics from the remote processing resources.

The sensor assembly may include an accelerometer and a gyroscope. The sensor assembly may include an internal sensor implemented as a Micro Electro Mechanical System (MEMS).

Further, this disclosure also includes a remote processing resource for deriving consumer analytics of a user as noted above. In one aspect, the remote processing resource may convey an offer to the user based at least in part on the consumer analytics. The remote processing resource may combine the consumer analytics for the user with consumer analytics regarding at least one additional user. The information received by the communications module may include sensor data from multiple devices associated with the user.

Still further, this disclosure also includes a system for deriving consumer analytics of a user as noted above. In one aspect, the remote processing resources of the system may be configured to convey an offer to the user based at least in part on the consumer analytics. The system may also include at least one additional portable device configured to output sensor data that is associated with the user, such that the information received by the remote processing resources further comprises sensor data communicated by the additional portable device.

The techniques described above may be implemented using any suitable sensor technology. In one aspect but without limitation, one or more sensors of device 100 may be based on MEMS. In many situations, operations known as sensor fusion may involve combining data obtained from multiple sensors to improve accuracy and usefulness of the sensor data, such as by refining orientation information or characterizing a bias that may be present in a given sensor. For example, many motion tracking systems combine data from a gyroscope, an accelerometer and a magnetometer.

In the described embodiments, a chip is defined to include at least one substrate typically formed from a semiconductor material. A single chip may be formed from multiple substrates, where the substrates are mechanically bonded to preserve the functionality. A multiple chip includes at least two substrates, wherein the two substrates are electrically connected, but do not require mechanical bonding. A package provides electrical connection between the bond pads on the chip to a metal lead that can be soldered to a PCB. A package typically comprises a substrate and a cover. Integrated Circuit (IC) substrate may refer to a silicon substrate with electrical circuits, typically CMOS circuits. MEMS cap provides mechanical support for the MEMS structure. The MEMS structural layer is attached to the MEMS cap. The MEMS cap is also referred to as handle substrate or handle wafer. In the described embodiments, an electronic device incorporating a sensor may employ a motion tracking module also referred to an SPU as noted above that includes at least one sensor in addition to electronic circuits. The sensor, such as a gyroscope, a compass, a magnetometer, an accelerometer, a microphone, a pressure sensor, a proximity sensor, or an ambient light sensor, among others known in the art, are contemplated. Some embodiments include accelerometer, gyroscope, and magnetometer, which each provide a measurement along three axes that are orthogonal relative to each other referred to as a 9-axis device. Other embodiments may not include all the sensors or may provide measurements along one or more axes. The sensors may be formed on a first substrate. Other embodiments may include solid-state sensors or any other type of sensors. The electronic circuits in the SPU receive measurement outputs from the one or more sensors. In some embodiments, the electronic circuits process the sensor data. The electronic circuits may be implemented on a second silicon substrate. In some embodiments, the first substrate may be vertically stacked, attached and electrically connected to the second substrate in a single semiconductor chip, while in other embodiments, the first substrate may be disposed laterally and electrically connected to the second substrate in a single semiconductor package.

In one embodiment, the first substrate is attached to the second substrate through wafer bonding, as described in commonly owned U.S. Pat. No. 7,104,129, which is incorporated herein by reference in its entirety, to simultaneously provide electrical connections and hermetically seal the MEMS devices. This fabrication technique advantageously enables technology that allows for the design and manufacture of high performance, multi-axis, internal sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

Although the present invention has been described in accordance with the embodiments shown, one of ordinary skill in the art will readily recognize that there could be variations to the embodiments and those variations would be within the spirit and scope of the present invention. For example, the above techniques have been discussed in the context of a retail venue, such as a store. However, in other embodiments, the concepts may be extended to other commercial venues as will be appreciated by those of skill in the art. As one illustration, a user's trajectory may define a route through a casino. The trajectory may involve a dwell period at one type of gaming table, but point of sale information may indicate the user did not participate. Here, the point of sale information may be derived from a player or loyalty card issued by the casino. Based on this unconverted interaction, an offer may be conveyed to the user, such as in the form of a free or bonus play at the gaming table or any advertisement with instructions how to play the appropriate game. Similarly, the trajectory may involve a route through a mall, hotel or other similar venue that may offers services such as restaurants or spas. If identified dwell periods in the trajectory indicate consumer interest, but resulted in an unconverted interaction, a retargeting offer may be conveyed to the user for the service outlet associated with the unconverted interaction. Accordingly, many modifications may be made by one of ordinary skill in the art without departing from the spirit and scope of the present invention.

What is claimed is:

1. A method for deriving consumer analytics of a first user, wherein the first user is associated with a portable device, comprising:
obtaining sensor data for the portable device representing motion of the portable device at a plurality of epochs over a first period of time;
deriving a trajectory for the portable device for the first period of time based at least in part on the sensor data;
identifying at least one dwell period within the trajectory;
obtaining point of sale information corresponding to the first period of time;
correlating each dwell period with product information; and
declaring at least one unconverted interaction based at least in part on a dwell period correlated with product information and the point of sale information, wherein the consumer analytics comprises the unconverted interaction.

2. The method of claim 1, further comprising conveying an offer to the first user based at least in part on the consumer analytics.

3. The method of claim 2, further comprising adjusting the offer based at least in part on a dwell period characteristic.

4. The method of claim 2, further comprising adjusting the offer based at least in part on the point of sale information.

5. The method of claim 2, further comprising adjusting the offer based at least in part on a purchase history of the user.

6. The method of claim 1, wherein declaring at least one unconverted interaction further comprises excluding a dwell period having a converted interaction based at least in part on the point of sale information.

7. The method of claim 1, wherein declaring at least one unconverted interaction further comprises distinguishing the unconverted interaction in a dwell period having a converted interaction based at least in part on a characteristic of the dwell period.

8. The method of claim 7, further comprising conveying an offer to the first user based at least in part on the unconverted interaction and the converted interaction.

9. The method of claim 1, wherein the determination of an interaction of the user with a product in an unconverted interaction is based on an interaction of the user with a product in a converted interaction.

10. The method of claim 1, wherein correlating each dwell period with product information is based at least in part on comparing a determined location of the first user during the dwell period with known locations of products.

11. The method of claim 1, wherein the product information correlated with a dwell period comprises a detail level.

12. The method of claim 11, further comprising determining an uncertainty for a determined location of the first user during the dwell period and wherein the detail level of the product information is based at least in part on the uncertainty.

13. The method of claim 11, further comprising conveying an offer to the first user based at least in part on the detail level of the product information.

14. The method of claim 11, wherein the dwell period encompasses a range of movement and wherein the detail level of the product information correlated with the dwell period is based at least in part on the range of movement.

15. The method of claim 1, further comprising determining posture information for the first user during a dwell period based at least in part on the sensor data, wherein the product information correlated with the dwell period is based at least in part on the determined posture information.

16. The method of claim 15, wherein the posture information is matched to a pattern learned from a previous converted interaction.

17. The method of claim 1, further comprising determining a use of the device during a dwell period, wherein declaring an unconverted interaction for the dwell period depends at least in part on the determined use.

18. The method of claim 1, further comprising deriving consumer analytics for a second user and combining the second user consumer analytics with the first user consumer analytics.

19. The method of claim 18, wherein the second user is selected from a group of users based at least in part on a relationship with the first user.

20. The method of claim 18, wherein the second user is selected from a group of users based at least in part on a comparison of the derived trajectory for the first user and a derived trajectory for the second user.

21. The method of claim 18, further comprising conveying an offer based at least in part on the combined consumer analytics.

22. The method of claim 21, further comprising selecting among the first and second users when conveying the offer.

23. The method of claim 1, further comprising conveying an offer to a second user based at least in part on the unconverted interaction, wherein the second user shares a characteristic with the first user.

24. The method of claim 1, further comprising obtaining sensor data from at least one other device associated with the user, wherein at least one of deriving the trajectory and identifying at least one dwell period is based at least in part on the sensor data obtained from the at least one other device.

25. A portable device associated with a user for deriving consumer analytics, the portable device comprising:
a) an integrated sensor assembly, configured to output sensor data representing motion of the portable device for the portable device at a plurality of epochs over a first period of time;
b) a consumer analytics module configured to:
i) obtain sensor data from the integrated sensor assembly;
ii) derive a trajectory for the portable device for the first period of time based at least in part on the sensor data;
iii) identify at least one dwell period within the trajectory;
iv) obtain point of sale information corresponding to the first period of time;
v) correlate each dwell period with product information; and
vi) declare at least one unconverted interaction based at least in part on a dwell period correlated with product information and the point of sale information, wherein the consumer analytics comprises the unconverted interaction.

26. The portable device of claim 25, wherein the consumer analytics module is further configured to obtain sensor data from another device associated with the user and to declare the at least one unconverted interaction using the sensor data from the other device.

27. The portable device of claim 26, wherein the portable device initiates communication of the sensor data from the other device when a dwell period is detected.

28. The portable device of claim 25, wherein the consumer analytics module is further configured to communicate the consumer analytics to remote processing resources.

29. The portable device of claim 28, wherein the consumer analytics module is further configured to receive an offer based at least in part on the consumer analytics from the remote processing resources.

30. A remote processing resource for deriving consumer analytics of a user, the remote processing resources comprising
a) a communications module for receiving information provided by a portable device associated with the user, wherein the information corresponds to a plurality of epochs over a first period of time of sensor data representing motion of the portable device; and
b) a consumer analytics module configured to:
i) derive a trajectory for the portable device for the first period of time based at least in part on the received information;
ii) identify at least one dwell period within the trajectory;
iii) obtain point of sale information corresponding to the first period of time;
iv) correlate each dwell period with product information; and
v) declare at least one unconverted interaction based at least in part on a dwell period correlated with product information and the point of sale information, wherein the consumer analytics comprises the unconverted interaction.

31. The remote processing resource of claim 30, wherein the remote processing resource is further configured to convey an offer to the user based at least in part on the consumer analytics.

32. The remote processing resource of claim 30, wherein the remote processing resource is further configured to combine the consumer analytics for the user with consumer analytics regarding at least one additional user.

33. The remote processing resource of claim 30, wherein the information received by the communications module comprises sensor data from multiple devices associated with the user.

34. A system for deriving consumer analytics of a user comprising:
a) a portable device comprising an integrated sensor assembly, configured to output sensor data representing motion of the portable device for the portable device at a plurality of epochs over a first period of time and a communications module for transmitting information corresponding to the epochs; and
b) remote processing resources configured to receive the information from the portable device and having a consumer analytics module configured to:
i) derive a trajectory for the portable device for the first period of time based at least in part on the received information;
ii) identify at least one dwell period within the trajectory;
iii) obtain point of sale information corresponding to the first period of time;
iv) correlate each dwell period with product information; and
v) declare at least one unconverted interaction based at least in part on a dwell period correlated with product information and the point of sale information, wherein the consumer analytics comprises the unconverted interaction.

35. The system of claim 34, wherein the remote processing resources are further configured to convey an offer to the user based at least in part on the consumer analytics.

36. The system of claim 34, further comprising at least one additional portable device configured to output sensor data that is associated with the user, wherein the information received by the remote processing resources further comprises sensor data communicated by the additional portable device.
